(19) United States
(12) Patent Application Publication
(10) Pub. No.: US 2020/0240362 A1
(43) Pub. Date: Jul. 30, 2020

(54) COMBINED CYCLE FLIGHT PROPULSION SYSTEMS

(71) Applicants: Yancheng You, Xiamen (CN); Zeyong Yin, Xiamen (CN); Jianfeng Zhu, Xiamen (CN); Yue Huang, Xiamen (CN); Chengxiang Zhu, Xiamen (CN); Liaoni Wu, Xiamen (CN); Yiwei Dong, Xiamen (CN)

(72) Inventors: Yancheng You, Xiamen (CN); Zeyong Yin, Xiamen (CN); Jianfeng Zhu, Xiamen (CN); Yue Huang, Xiamen (CN); Chengxiang Zhu, Xiamen (CN); Liaoni Wu, Xiamen (CN); Yiwei Dong, Xiamen (CN)

(73) Assignee: Xiamen University, Xiamen (CN)

(21) Appl. No.: 16/696,910

(22) Filed: Nov. 26, 2019

Related U.S. Application Data
(60) Provisional application No. 62/797,569, filed on Jan. 28, 2019.

(51) Int. Cl. F02K 7/16

(52) U.S. Cl. CPC F02K 7/16

(57) ABSTRACT

A combined cycle propulsion system (CCPS) module combines a low-speed propulsion system (LSPS) such as a turbojet and a high-speed propulsion system (HSPS) such as dual mode ramjet engines with a mid-speed propulsion system (MSPS) such as a ejector ramjet engine to close a thrust gap between the upper operation limit of the LSPS and the lower operation limit of the HSPS in a flight vehicle. A cooling system ensures thermal protection of the non-operating LSPS during MSPS or HSPS operation by cooling tapped air from the MSPS or HSPS using a heat exchanger and expansion in a turbine/generator and directing cooled tapped air into the LSPS.

### CROSS-REFERENCE TO RELATED APPLICATIONS

This patent document claims benefit of the earlier filing date of U.S. Provisional Pat. App. No. 62/797,569, filed Jan. 28, 2019, which is hereby incorporated by reference in its entirety.

### BACKGROUND

Some types of flight propulsion systems for operation in the subsonic, supersonic, and hypersonic regimes include rockets, turbojets, ejector ramjets, and dual mode ramjets. While rockets function at any Mach number, state-of-the art turbojets generally operate over a Mach range from 0 to about 2.5. Ejector ramjets generally operate at lower Mach numbers, e.g., Mach 0 to 2.5, in ducted rocket mode and at higher Mach numbers, e.g., Mach 2.5 to 4.3, in mechanically choked ramjet mode. Dual mode ramjets generally operate at lower Mach numbers, e.g., Mach 4 to 5.5, in thermally choked ramjet mode and at higher Mach numbers, e.g., Mach>5.5, in scramjet mode.

Combined cycle propulsion systems using a graduating series of propulsion systems are being developed to operate over wide Mach ranges. In particular, a Rocket-Based Combined Cycle (RBCC) propulsion system may include a dual mode ramjet and a ducted rocket that share the same flow path. A Turbine Based Combined Cycle (TBCC) propulsion system, in contrast, may combine a turbojet with one or more other types of “airbreathing” propulsion systems such as a ramjet or a dual mode ramjet. Airbreathing engines use atmospheric air as a source of oxygen for combustion as opposed to rockets, which carry and use on-board oxygen sources. Airbreathing flight propulsion systems may need to be larger and more massive to capture and use oxygen from the atmosphere, but airbreathing flight propulsion systems are generally several times more efficient than rockets in terms of specific impulse. In particular, specific impulse, which may be defined as thrust produced per unit of the sum of on-board fuel and oxidizer flow, may be higher for pure airbreathing systems because the on-board oxidizer flow is zero resulting in a larger specific impulse.

Currently published TBCC system proposals typically suffer from four major problems: (1) Insufficient take-off and transonic (M=˜1) push-through thrust; (2) Insufficient thrust between the high end of turbojet operation, e.g., M=1.6 to 3.5, depending on the turbojet design, and the low end of an engine, such as a Dual Mode Ramjet (DMRJ), capable of operating at higher Mach numbers, e.g., M=2.5 to 4 depending on DMRJ design; (3) Inability to smoothly and efficiently transition during vehicle acceleration from one TBCC component propulsion system to another, e.g., from turbojet operation to DMRJ operation; and (4) A lack of thermal protection (a.k.a. cocooning) of the turbojet upon an in-flight shutdown of the turbojet to assure a reliable in-flight restart of the turbojet.

The problems occurring in flight after turbojet shutdown in a TBCC have two major elements. First, rotor core heat needs to be removed from the turbojet to avoid binding between the hot turbine wheel and the cooling and as such contracting turbine housing. Second, turbine bearings and other mechanical structures, control electronics, and seals in the turbojet must remain within safe temperature limits while the turbojet is shutdown, despite heat flowing into the turbojet compartment through radiation and conduction through engine mounts (from other operating propulsion systems), and convection (from seal leakage of inlet and exit flow control panel devices). Cocooning of the turbojet in a TBCC system to protect it from thermal problems adds complexity and mass to the system, and the added mass may be in excess of the available vehicle payload. Accordingly, most, if not all published TBCC systems currently ignore both post-shutdown and restart issues.

Literature available on TBCC engine concepts include three published concepts that typify some of the issues, drawbacks, inadequacies, limitations, requirements, or specific in-flight complications of TBCC propulsion systems.

Melvin Bulman and Adam Siebenhaar, “Combined cycle propulsion: Aerojet innovations for practical hypersonic vehicles,” 17th AIAA International Space Planes and Hypersonic Systems and Technologies Conference, 2011, AIAA 2011-2397 describes a TBCC propulsion system sometimes referred to herein as the “TriJet concept.” The TriJet concept employs an inward turning inlet that supplies airflow to a state-of-the-art turbojet, an ejector ramjet (ERJ) with a bi-propellant rocket primer, and a dual mode ramjet (DMRJ). The TriJet concept further employs two nozzles, one for the state-of-the-art turbojet and a single expansion ramp nozzle (SERN) that integrates the exhaust flows of the ERJ and the DMRJ. Hinged doors operated dependent on the flight Mach number control the inflows to the various engines and the exhaust flows into the nozzles.

Baoxi Wei, Wenhui Ling, Feiteng Luo, and Qiang Gang, “Propulsion Performance Research and Status of TRRE Engine experiment,” 21st AIAA International Space Planes and Hypersonics Technologies Conference, (AIAA 2017-2351) discloses a Turbo-aided Rocket-augmented Ramjet Engine (TRRE) concept. The TRRE concept employs an over-under inlet that supplies airflow to a turbojet, a DMRJ with a flowpath integrated thrust augmentation rocket, and a common SERN that integrates the exhaust flow of the turbojet and the DMRJ. The inflows to the various engines and the exhaust flows into the common nozzle are controlled by hinged doors that are positioned as a function of the flight Mach number.

The US SR-72 concept, or so called “Over-Under” concept, was featured in Aviation Week, “Integrated propulsion breakthrough key to Skunk Works' hypersonic SR-72 concept”, Nov. 1, 2013 Guy Norris|Aviation Week & Space Technology. The Over-Under concept employs a common inlet that supplies airflow to a turbojet and a DMRJ, and a SERN integrates the exhaust flows of the two engines. The turbojet required for the Over-Under concept is currently beyond the state of the art, being required to operate at high temperature and up to Mach 3 to 4.

These concepts or proposals generally address the common TBCC problems of insufficient take-off and transonic push-through thrust, insufficient thrust between the high end of turbojet operation and the low end of DMRJ operation, and transitions during vehicle acceleration from one TBCC integrated propulsion system to another. The current proposals, however, do not address the cocooning problem. Without a solution to this problem, the concepts are not feasible.

### BRIEF DESCRIPTION OF THE DRAWINGS

FIGS. 1A and 1B respectively show bottom and top views of a symmetric combined cycle propulsion system module with a “scarved” inward turning common inlet and a “scarved” outward turning common nozzle.

FIGS. 2A and 2B respectively show a front view and a cross-sectional view of a “scarved” inward turning common inlet and forward air ducts that connect the common inlet to propulsion systems in a combined cycle propulsion system (CCPS) module.

FIG. 2C shows a cross-section of a port or starboard forward air transfer duct that connects the common inlet with a port or starboard propulsion system of a CCPS module.

FIG. 3A shows a rear view into a “scarved” outward turning common nozzle of a CCPS module.

FIG. 3B shows a cross-sectional view of the “scarved” outward turning common nozzle and aft air ducts that connect propulsion systems to the common nozzle of the CCPS module.

FIG. 3C shows a cross-section of a port or starboard air transfer duct that connects a port or starboard propulsion system with the common nozzle of the CCPS module.

FIG. 4 is a graph illustrating distribution of the total captured inlet flow to propulsion systems during typical CCPS operation over the Mach regime from 0 to 6.

FIG. 5 shows a cross section of a high-speed propulsion system implemented with a dual mode ramjet (DMRJ).

FIG. 6 shows a cross section of a low-speed propulsion system implemented with a turbojet having air conditioning provisions for thermal management after in-flight shutdown.

FIG. 7 shows a cross section of a mid-speed propulsion system implemented with an ejector ramjet.

FIG. 8 is a schematic of an air conditioning system for the cocooning of a turbojet in a CCPS module.

FIG. 9 is a flow diagram of one implementation of a flight process using a CCPS module including a dual-mode ramjet, a turbojet, and an ejector ramjet.

FIGS. 10A, 10B, and 10C illustrate arrangements of individual or multiple CCPS modules for flight vehicles.

The drawings illustrate examples for the purpose of explanation and are not of the invention itself. Use of the same reference symbols in different figures indicates similar or identical items.

### DETAILED DESCRIPTION

Combined cycle propulsion systems (CCPSs) as disclosed herein integrate multiple engine components, e.g., a low-speed propulsion system (LSPS), and a mid-speed propulsion system (MSPS), and a high-speed propulsion system (HSPS), into a module having a common inlet and a common nozzle. The various propulsion systems in a CCPS module generally operate sequentially with some overlap during the transition from one type of propulsion to the next. Depending on the specific configuration, a CCPS module may be laterally symmetric or laterally asymmetric with respect to the common inlet, the common nozzle, and the engines selected for the propulsion systems. Depending on the sizes and masses of modules, flight vehicles can be configured with various combination of CCPS modules, for example, one or more symmetric CCPS modules, one or more pairs of mirrored asymmetric CCPS modules, or a mix of symmetric and asymmetric CCPS modules.

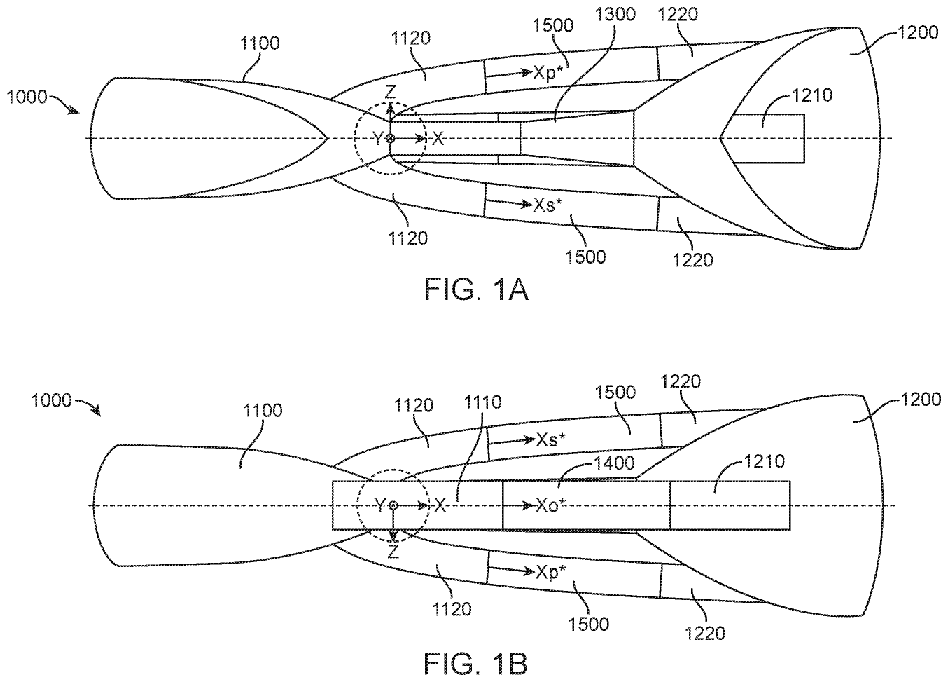

FIGS. 1A and 1B respectively show bottom and top views of an example implementation of a CCPS module 1000, which integrates multiple engine components, e.g., a high-speed propulsion system (HSPS) 1300, a low-speed propulsion system (LSPS) 1400, and a mid-speed propulsion system (MSPS) 1500. CCPS module 1000 includes a “scarved” inward-turning inlet 1100 and a “scarved” outward-turning common nozzle 1200. “Scarving” is a shaping or feature of inlets and nozzles that may reduce the weight of a large inlet or nozzle and may provide off-design flow spillage that produces a vehicle pitch moment. In particular, inlet 1100 may allow off-design flow spillage that produces a positive vehicle pitch moment that offsets a negative pitch moment created in scarved nozzle 1200 or elsewhere in CCPS module 1000. Use of a scarved inlet 1100 and/or nozzle 1200 can thus reduce or minimize vehicle control authority required during flight.

A HSPS flow path in CCPS module 1000 includes inlet 1100 feeding air in an X-direction to a combustor of HSPS 1300 and exhaust from HSPS 1300 exiting to common nozzle 1200. An LSPS flow path in CCPS module 1000 includes a forward transition or bypass duct 1110 from inlet 1100 to an engine of LSPS 1400, and an aft-transition duct 1210 from the engine of LSPS 1400 to the common nozzle 1200. The MSPS flow path includes two parallel (port and starboard) bypass ducts, each including a forward transition duct 1120 from inlet 1100 to an engine of MSPS 1500 and an aft-transition duct 1220 from that MSPS engine to common nozzle 1200. Flows through the various bypass ducts 1110 and 1120 are in respective Xo*, Xp*, and Xs* directions, which may be at different angles and offsets from the X-direction defining flow into the HSPS 1300.

An exemplary configuration of CCPS module 1000 can employ a turbojet in LSPS 1400, two ejector ramjets (ERJs) in MSPS 1500, and a Dual Mode Ramjet (DMRJ) in HSPS 1300, providing the capability to operate such a configuration of CCPS module 1000 over a flight regime range of Mach 0 to 6.

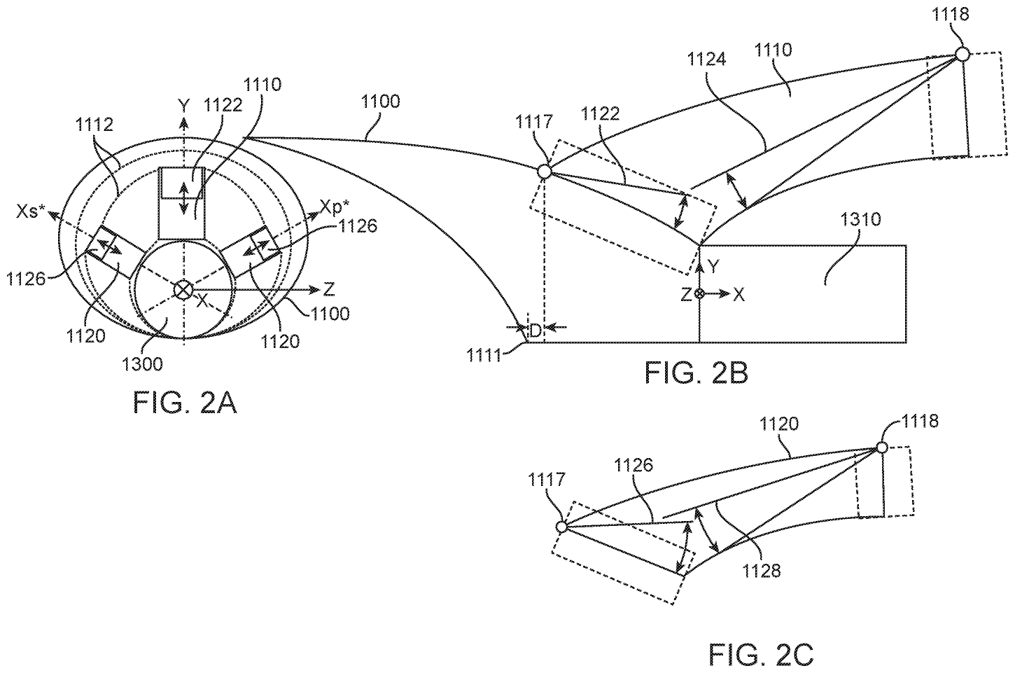

FIGS. 2A, 2B, and 2C respectively show a front view of scarved inlet 1100, a cross-sectional view through scarved inlet 1100, bypass duct 1110, and part of HSPS 1300, and a cross-sectional view of a bypass duct 1120. In the illustrated configuration of FIGS. 2A, 2B, and 2C, HSPS 1300 and LSPS 1400 are arranged to have flows with center lines in a central X-Y plane, and MSPS 1500 includes two flow paths and engines symmetrically arranged on opposite sides of the central X-Y plane. The front view shown in FIG. 2A is along the direction of the entering air flow into inlet 1100 and shows contour lines 1112 illustrating the generally concave shape of inlet 1100. Inlet 1100 has fixed/immovable external and internal walls. An X axis, which extends through a central channel for HSPS 1300 of CCPS module 1000, is along the direction of air flow into inlet 1100. A plane perpendicular to the X-direction is defined by directions Y and Z, which are orthogonal to each other. Bypass channel 1110, which directs flow from inlet 1100 to LSPS 1400, is located above the central channel to HSPS 1300 with a center line in the X-Y plane. The two bypass channels 1120 of MSPS 1500 are respectively centered in X-P and X-S planes. Planes X-P and X-S are rotated relative to the X-Y plane by an angle θ, e.g., by plus and minus 60 degrees, respectively. More generally, angle θ of the X-P and X-S planes relative to the X-Y plane may be selected based on overall packaging considerations for CCPS module 1000. The two bypass channels 1120, with center lines located in the X-P and X-S planes, respectively, direct flows from inlet 1100 to starboard and port engine components of MSPS 1500.

HSPS 1300 in this exemplary and other configurations has a channel that is always open, but peripheral channels 1110 and 1120 can be gradually opened and closed using respective air flow control systems including a set of hinged inlet flow control panels 1122 and 1124 for bypass duct 1110 and a set of hinged inlet flow control panels 1126 and 1128 for each bypass duct 1120. In order to achieve the ability to vary the internal inlet contraction, the hinge point of drive systems 1117 of each forward panel 1122 or 1126 is located inside the internal contraction section of inlet 1100, which starts at a plane defined by a “crotch” 1111 of inlet 1100. That means that the hinge points of drive systems 1117 are a distance D in the X-direction behind crotch 1111. Lowering internal inlet contraction is significant when attempting to start HSPS 1300. (“Start” stands here for achieving supersonic flow inside a duct.) Once started, the contraction in HSPS 1300 can be increased by moving panels 1122 and 1126 into their respective closed positions without “unstarting” the HSPS. When an inlet panel is in a closed configuration, the air flow to the respective channel is blocked. When an inlet flow control panel 1124 or 1126 is open, partially or fully, air flow from inlet tube 1100 is directed into channel 1110 or 1120. In general, air flow from inlet 1100 is thus split, flows through, and exits through all partially or fully open channels, including the channel of HSPS 1300. Flow control panels 1122, 1124, 1126, and 1128 are located in the forward channel transition sections 1110 and 1120. As illustrated these forward transition ducts 1110 and 1120 may have rectangular cross section whose aspect ratios change along their centerlines. Rectangular ducts permit rotation of the rectangular hinged panels 1122, 1124, 1126, or 1128 and appropriate sealing along the duct sidewalls.

Each individual flow control panel system on the inlet side as shown in FIGS. 2B and 2C includes a pair of hinged panels, with a front panel 1122 or 1126, that when closed forms the interior wall of inlet 1100, and a back panel 1124 or 1128 within bypass duct 1110 or 1120. The flow control panel system may include independent hinge and drive systems 1117 and 1118 to open and close any front panel 1122 or 1126 and any back panel 1124 or 1128. Although flow control using a single panel system may be possible, addition of back panels 1126 and 1128 provides important functions. In particular, the back panel 1124 or 1128 may always stay behind the associated front panel 1122 or 1126 and as such may be used to minimize recirculation flow at the trailing edge of the front panel 1122 or 1126. Keeping back panel 1124 or 1128 behind front panel 1122 or 1126 may also prevent the leading edge of the back panel from being directly exposed to the incoming flow. Additionally, the gaps formed between the tips of panel sets 1122-1124 and 1126-1128 can be used for bleeding low energy air.

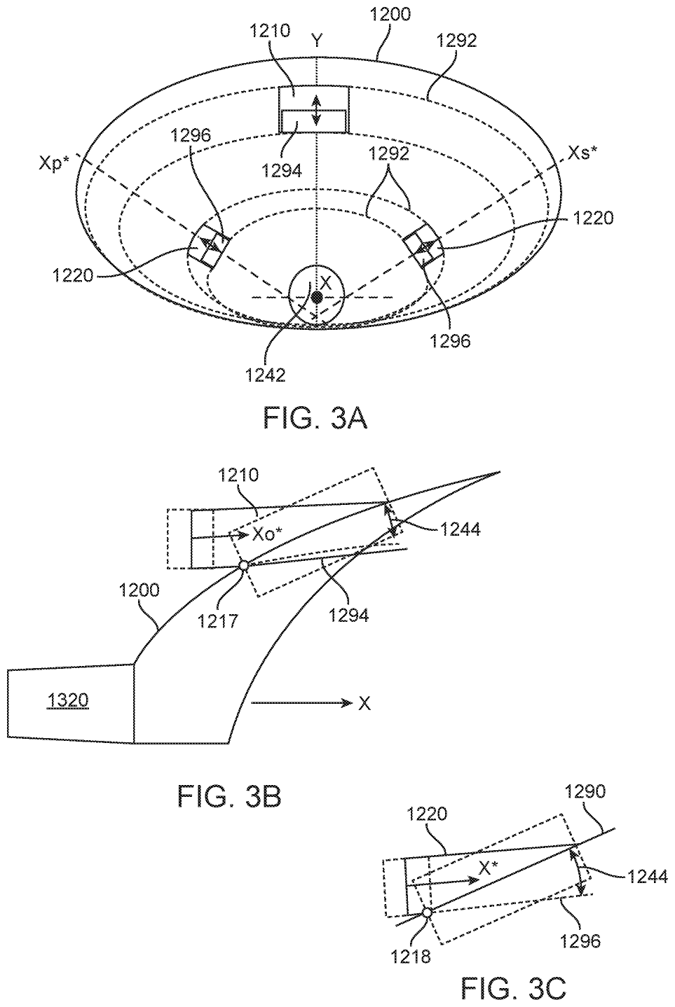

FIG. 3A shows a rear view of common nozzle 1200, which is against the direction of the exhaust flow. FIG. 3A particularly shows scarved nozzle 1200 with contour lines 1292 illustrating the generally concave shape of nozzle 1200. FIG. 3B shows a cross section along the X-Y plane through exhaust duct 1210 and nozzle 1200, and FIG. 3C shows a cross section through one of the port and starboard exhaust ducts 1220 to nozzle 1200. Exhaust channel 1320 from HSPS 1300, exhaust channel 1210 from LSPS 1400, and exhaust channels 1220 from MSPS 1500 are all directed into the common exhaust nozzle 1200. HSPS channel 1242 is always open in this configuration. LSPS 1400 and MSPS 1500, however, have exhaust flow control panels 1294 and 1296 that may be opened or partially open to control exhaust flow when LSPS 1400 or MSPS 1500 are in operation and are typically closed when LSPS 1400 or MSPS 1500 are not in use. As illustrated, the aft transition ducts 1210 and 1220 may have rectangular cross section at nozzle 1200 and may have aspect ratios or shapes that change along the centerlines of ducts 1210 and 1220. The flow control panel systems may include independent hinge and drive systems 1217 and 1218 to open and close the respective panels 1294 and 1296.

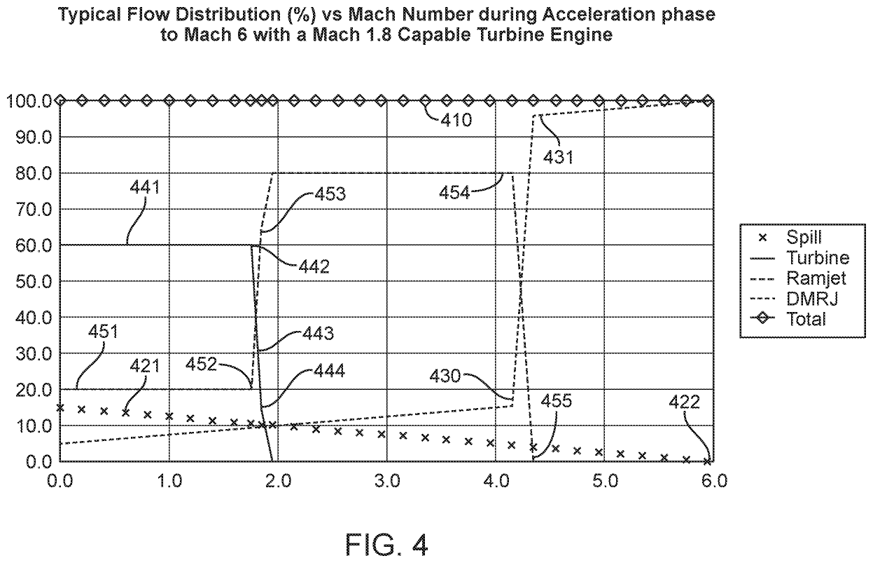

The total flow captured (the 100% level) by the inlet of a CCPS module is a function of flight Mach number and altitude of flight. Assuming a typical Mach-altitude flight profile for a hypersonic vehicle, the total flow captured can be expressed as a function of Mach number only. A typical flow management scheme for a CCPS module during flight is illustrated in FIG. 4. FIG. 4 particularly shows how the percentage flows through the various propulsion systems 1300, 1400, and 1500 may be managed with forward control panels 1122, 1124, 1126, and 1128 and aft control panels 1294 and 1296 in an exemplary configuration where CCPS module 1000 includes a DMRJ in HSPS 1300, a single trubojet engine in LSPS 1400, and a pair of ERJs in MSPS 1500. At lower speeds, inlet 1100 has a spill flow 421, which is an air flow that leaves inlet 1100 through the “scarved” feature of inlet 1100. (In general, spill flow 421 is the difference between the total flow 410 that inlet 1100 captures and the sum of the flows of the center channel and the three bypass channels.) At the HSPS design point 422, here selected at Mach 6, the spill flow 421 is zero.

The trubojet flow channel is wide open at Mach 0 to maintain a maximum available flow 441 to the turbojet until a point 442, corresponding to Mach 1.8 as an example, where the percentage flow to the turbojet begins to decrease and the percentage to the ejector ramjets begins to increase. Between Mach 1.8 and 2, the turbojet channel of LSPS 1400 receives a decreasing flow 443 that decreases to about 15% of the maximum available flow 410 at a point 444. Flow 443 may initially be used for operation of the turbojet simultaneously with operation of the ejector ramjets and may later be used for cooling the core of the then shut down but windmilling turbojet. After core-cooling, at point 444, the turbine flow through LSPS 1400 is completely shut off.

Percentage air flow 451 to MSPS 1500 may be 20%, for example, during solo operation of the turbojet. The MSPS flow 451, more generally, may be non-zero and may be chosen to reduce drag-inducing spill flow from the common inlet. Additionally, the common nozzle of the CCPS may be too large for the flow received if MSPS flow 451 were zero, which could cause unwanted nozzle performance losses during operation of turbojet alone. At point 452, when percentage air flow to the turbojet starts decreasing, percentage air flow to MSPS 1500 starts increasing to be used in the ejector ramjets of MSPS 1500 for mid-speed thrust production. The ejector ramjets may be employed together with the turbojet to provide thrust until a point 453, when the turbojet is shut down. After the turbojet is shut down, the thrust to further accelerate the vehicle may come only from MSPS 1500, e.g., the ejector ramjets, until about Mach 4.2 at which point 454, the ramjet duct panels are closing, and HSPS flow 430 increases as the ERJ duct panels close. Equal flows between ramjet and DMRJ ducts may be achieved around Mach 4.3. Full DMRJ flow occurs at a point 455 when the ERJ flow is shut off and the DMRJ flow 431 is almost at 100% of inlet flow 410 except for the residual spill flow, which goes to zero at the DMRJ design point at Mach 6. Over the entire acceleration phase from Mach 0 to 6, the sum of all flows is 100% of the total captured flow 410.

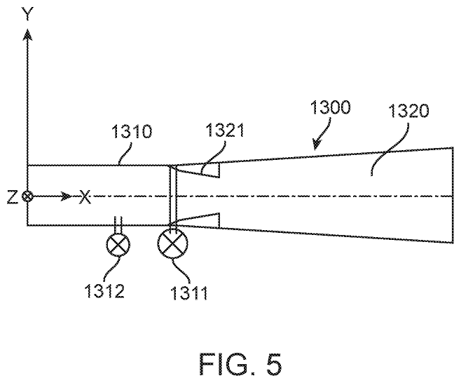

FIG. 5 shows a cross-section of one configuration of HSPS 1300. In the illustrated configuration, HSPS 1300 includes a Dual Mode Ramjet (DMRJ) having an isolator 1310 with an HSPS fuel valve 1311 and a high-pressure air tap-off valve 1312 and a diverging combustor 1320 with fuel injection ramps 1321. Air tap-off valve 1312 may be used to supply flow to air conditioning system for a turbojet as described further below. Isolator 1310 and combustor 1320 may have circular cross sections in a conventional DMRJ.

A CCPS module employing a DMRJ such as shown in FIG. 5 may sense “Unstart” conditions when the common inlet of the CCPS module directs more supersonic flow to the HSPS 1300 than HSPS 1300 can absorb. To remedy this condition, the closed MSPS panels may be opened slightly, or the partially open MSPS panels are opened further, to relieve the internal inlet contraction and as such stabilize the flow in the HSPS 1300 by letting excess flow escape through the MSPS channels.

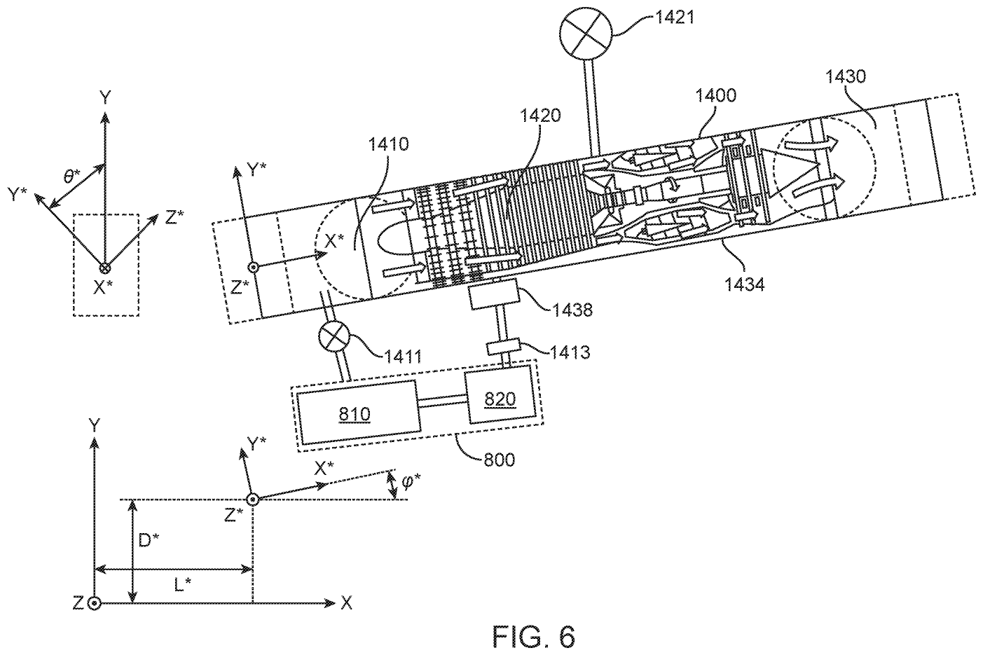

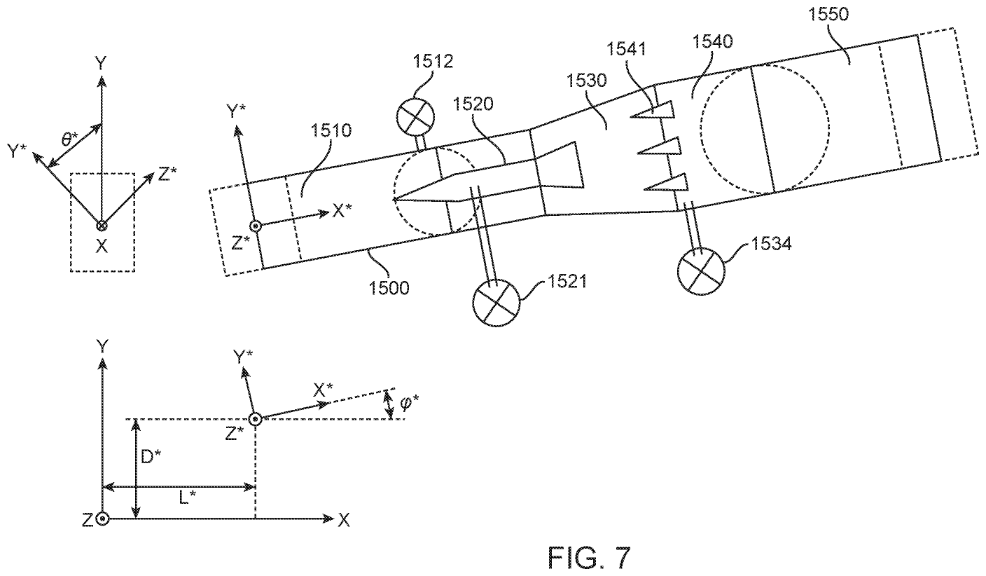

FIG. 6 shows a cross-section in the X-Y plane of LSPS 1400 in an exemplary implementation including a turbojet 1420, sometimes referred to as turbine engine (TE) 1420. The LSPS body coordinate system X*, Y*, Z* shown in FIG. 6 is related to the CCPS body system X, Y, Z of the HSPS 1300 through a translation by L* and D* in X and Y directions, respectively, and a rotation of θ* about the X-axis, and a rotation of φ* about the Z*-axis. For CCPS module 1000 in the exemplary configuration, the angle θ*=0. An inlet duct 1410 to turbojet 1420 has a cross section that transitions from rectangular, e.g., at the common inlet, to circular at the front of turbojet 1420, and the exit duct section 1430 transitions from circular at the back of turbojet 1420 to rectangular. When LSPS 1400 of FIG. 6 is employ in CCPS module 1000 of FIG. 1B, the total LSPS flowpath consists of the inlet transition ducts 1110 and 1410, the turbojet 1420, and the exhaust transition ducts 1430 and 1210. Turbojet 1420 includes a fuel valve 1421 installed between duct sections 1410 and 1420. A turbine engine air conditioning system 800 receives high pressure and high temperature air from an air tap-off valve 1312 or 1512 in either HSPS 1300 or MSPS 1500 (see FIG. 5 or 7) and delivers cooled air to a turbine inlet duct valve 1411 while in turbojet cooling mode. A switch 1413 may also be closed energizing a start motor 1438, which causes a turbine rotor 1434 of turbojet 1420 to spin during the cooling mode.

FIG. 7 shows a cross-section in an X*-Y*-plane of MSPS 1500 in a configuration where MSPS 1500 includes an ejector ramjet engine 1540. The MSPS body coordinate system X*, Y*, Z* used in FIG. 6 is related to the CCPS body system X, Y, Z through translations by L* and D* in X and Y directions, respectively, a rotation of θ* about the X-axis, and a rotation of φ* about the Z*-axis. An inlet duct 1510 cross section may transition from rectangular at the common inlet to circular at the front of ERJ 1540, and exit duct section 1550 may transitions from circular at the back of ERJ 1540 to rectangular at the exit of duct 1550. When MSPS 1500 of FIG. 7 is used in CCPS module 1000 of FIG. 1B, the total MSPS flowpath consists of the inlet transition ducts 1120 and 1510, the ejector ramjet engine 1530, and the exhaust transition ducts 1550 and 1220. ERJ 1540 in the illustrated configuration includes an ejector rocket 1520, a set of propellant valves 1521, a mixer section 1530, several ramjet fuel injectors/flame-holders 1541, and a ramjet fuel valve 1534, which are installed between duct sections 1510 and 1550. A high-pressure air tap-off valve 1512 is located in inlet duct 1510 and may be used to direct air flow to a turbine engine air conditioning system 800 as described elsewhere herein.

One configuration of a CCPS module may have port and starboard ejector ramjet systems with each being similar or identical to the system illustrated in FIG. 7. Port and starboard MSPS-ejector ramjet engines may particularly be located in symmetrical locations in an exemplary configuration of CCPS module 1000. For example, a body coordinate system X*, Y*, Z* of the port ejector ramjet engine may be related to the CCPS body system X, Y, Z through a translation by L* and D*, respectively, a rotation of φ* about the Z*-axis, and a rotation of −θ* about the X-axis, while a body coordinate system X*, Y*, Z* of the starboard ejector ramjet engine may be related to the CCPS body system X, Y, Z through a translation by L* and D* in X and Y directions, respectively, a rotation of φ* about the Z*-axis, and a rotation of +θ* about the X-axis.

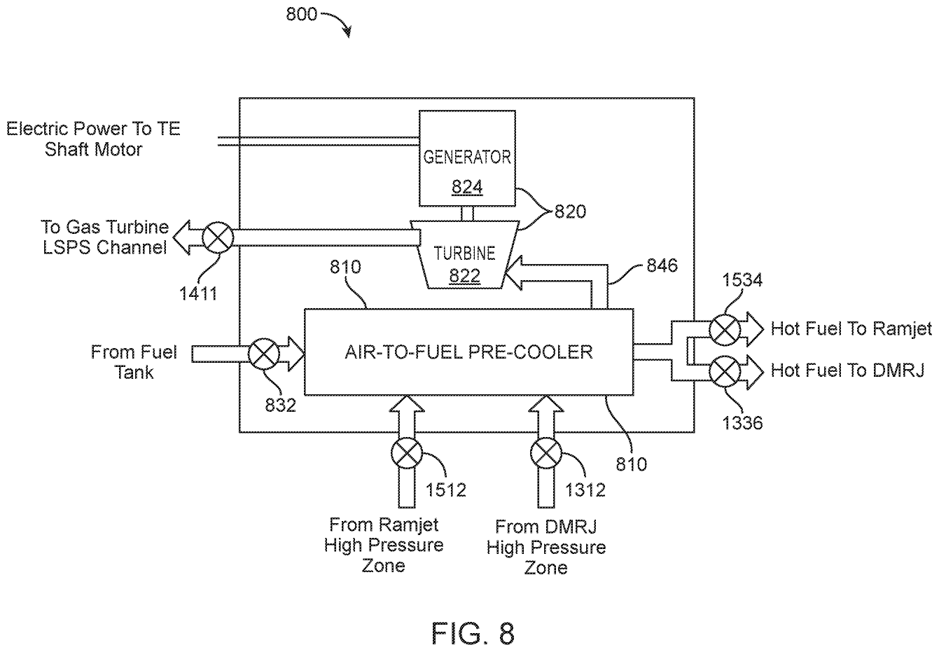

Thermal protection of a turbojet for any CCPS configuration may include two sequential processes, core heat removal and engine compartment cooling. Core heat removal may begin immediately after the turbojet is shut down and may remove core heat from the engine rotor through passive “windmilling.” In particular, after a turbojet 1420 is shut down, i.e., while no fuel is being fed to turbojet 1420, LSPS inlet flow control panel set 1122-1124 and exhaust panel 1294 may remain fully or partly open for air flow and rotation of the engine rotor. Windmilling in this fashion may generally remove heat only when the turbojet 1420 is shut down at below about Mach 2. At Mach 1.8 to 2.0 and at 10,000 ft, a typical flight altitude for this speed, the recovery temperature of the inlet air may be about 170 to 210° F., which is cool enough to remove heat from turbojet 1420. At higher Mach numbers, the inlet air may be above 210° F. and is likely too hot to effectively cool the hot turbojet core. Inlet flow control panel set 1122-1124 is closed after completion of core heat removal and at speeds higher than Mach 2, and a turbine engine air conditioning system (TEACS) 800, shown in FIG. 6 and in more detail in FIG. 8, is activated to maintain a safe air temperature within inlet channel 1110 and turbojet 1420. Dependent on the flight speed, TEACS 800 may be operated in conjunction with either MSPS 1500 or HSPS 1300.

TEACS 800, as shown in FIG. 8, includes an air-to-fuel pre-cooler 810 and a turbo generator 820. Pre-cooler 810 is a heat exchanger that transfers heat from an air flow to the on-board fuel, e.g., to a flow of fuel from on-board tanks, through a fuel valve 832, to a pre-cooler 810, and a fuel valve 1534 to MSPS 1500 or a fuel valve 1336 to HSPS 1300. Turbo generator 820 includes a gas turbine 822 directly coupled to an electrical power generator 824. In operation, high pressure, high temperature air flow, through either ERJ tap off flow valve 1512 or DMRJ tap off flow valve 1312 depending on whether ERJs 1500 or DMRJ 1300 is operating, is tapped off. Pre-cooler 810 cools the tapped airflow from valve 1512 or 1312 to produce an airflow 846 having a temperature not exceeding the thermo-structural material limits of the turbo generator 820, e.g., below about 1,000° F. The fuel heated in pre-cooler 810 is fed to ERJs 1599 or DMRJ 1300 through valve 1534 or 1336. In turbine 822, the air from flow 846 expands to a temperature suitable for LSPS 1300 component temperature conditioning, e.g., about 200° F. to 250° F. The expansion pressure of cooled air fed from turbine 822 through valve 1411 to LSPS 1400 may be slightly above the inlet pressure at a location downstream of the closed LSPS inlet flow control panel set 1122-1124. Pressurizing LSPS inlet channel 1110 helps prevent hot inlet gas from leaking from inlet 1100, through panel set 1122-1124, into LSPS inlet channel 1110. Exhaust flow control panel 1294 may be slightly open at this time to allow the cooling gas to exit through turbojet 1420 into nozzle 1200. Turbo generator 820 may provide electric power through a switch 1413 to a turbine engine rotor starter motor 1438. Rotor shaft motor 1438 can then slowly but continuously rotate the rotor of turbojet 1420 to assure good temperature distribution in the rotor. TEACS 800 eliminates the need to carry coolant aboard the flight vehicle to protect turbojet 1420 and components associated with the turbojet 1420 from convective hot seal leakage and from radiant and conductive heat transfer from the surrounding channel structure.

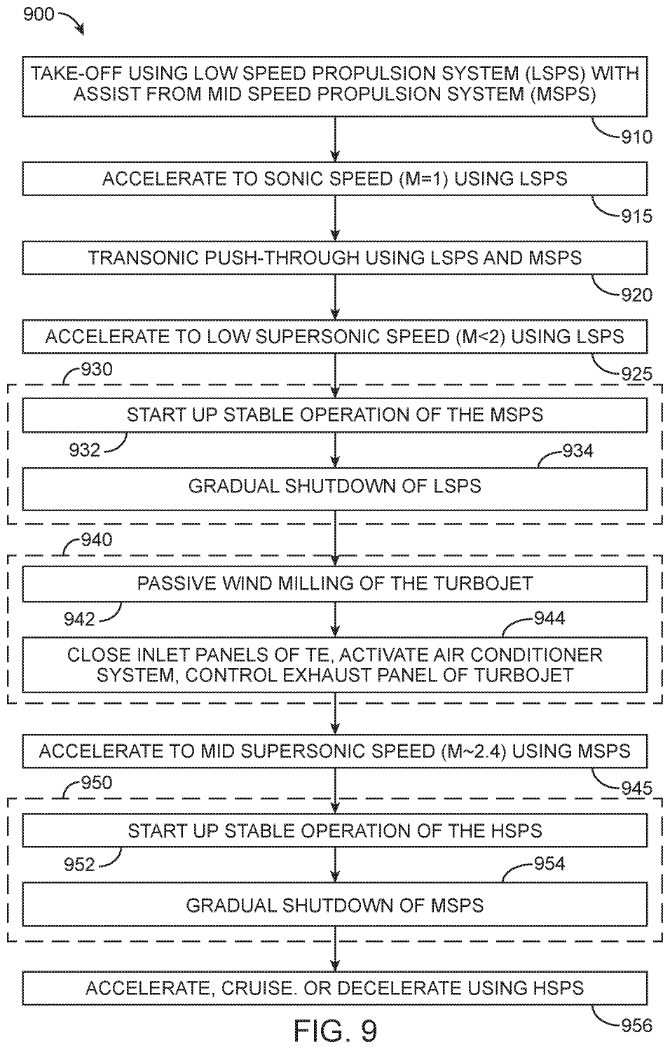

FIG. 9 is a flow diagram of a flight process 900 for using CCPS module 1000 and other CCPS module configuration variants described below. For flight process 900, a take-off operation 910 may use the LSPS with an assist from the MSPS. In particular, thrust from turbojet 1420 of FIG. 6 may be supplemented with thrust from ejector rockets 1520 of the ERJs 1540 of FIG. 7 if required by the total thrust needs for take-off. Thrust enhancing ejector function may be minimal due to low dynamic pressure in the ejector channels 1510 flow at the low take-off speeds. A subsonic acceleration operation 915 may use LSPS thrust, e.g., turbojet thrust only following take-off operation 910. A transonic push-through operation 920 may again employ the LSPS with an MSPS assist. For example, the turbojet thrust may be supplemented with the ERJ-rocket only thrust if required for transonic push-through. A low supersonic acceleration operation 925 may again use the LSPS only, e.g., turbojet thrust only, after transonic push-through operation 920. For each of operations 910, 915, 920, and 925, the flight control system opens inlet and exhaust flow control panel sets for operation of the turbojet, and inlet and exhaust flow control panel sets may be opened for operation of ERJ rocket when required, e.g., during takeoff operation 910 and transonic push-through operation 920.

A two-step transition 930 from LSPS operation to MSPS operation in flight process 900 includes an ERJ start-up operation 932 and an LSPS shutdown operation 934. ERJ start-up operation 932 opens flow control panel sets and supplies fuel for stable operation of the ERJs in parallel with ongoing turbojet operation, and once that is accomplished, LSPS shutdown operation 934 gradually shuts down the LSPS, e.g., reduces fuel supplied to turbojet. A thermal management process 940 maintains the LSPS in a safe temperature ranges while the LSPS is shutdown. A windmilling process 942 of thermal management process 940 immediately follows shutdown operation 934 and initially cools a turbine rotor of the turbojet through passive windmilling with the LSPS channel inlet and exit panels open while operating at flight speeds not exceeding Mach 2. A maintenance operation 944 of thermal management process 940 closes/seals inlet flow control panel set 1122-1124 of the turbojet channel, controls exhaust flow control panel 1294 of the turbojet, e.g., so that exhaust flow control panel 1294 may be slightly open, and activates flow from air conditioner system 800 into turbojet 1420. Temperature maintenance operation 944 with closed inlet flow control panel set 1122-1124 may continue while turbojet 1420 is shutdown, including during higher speed operations of flight process 900, e.g., including a mid-supersonic flight operation 945, a HSPS startup operation 950, and high-speed flight operation 956.

Mid supersonic flight operation 945 can be conducted with ERJs 1500 only up to a speed of about Mach 4.2. When accelerating to speeds above about Mach 4.2, HSPS startup operation 950 may employ a two-step transition from the MSPS to the HSPS. A HSPS startup operation 952 starts up and begins stable operation of the HSPS in parallel with ongoing MSPS operation, and then an MSPS shutdown operation 954 gradually shuts down the MSPS and closes of MSPS channel inlet doors 1126 and exhaust flow control panel 1296. A high-speed flight operation 956 may continue supersonic acceleration, cruise, and deceleration using the HSPS only, e.g., only DMRJ thrust.

The operations of flight process 900 are reversible. For example, a reverse of operation 950 provides two-step transition from HSPS to MSPS operation, e.g., from DMRJ operation to RJ only operation. The reverse of operation 950 gradually powers up MSPS during deceleration to suitable flight speeds and then shuts down the HSPS when flight decelerates to about Mach 4.2. A reversal of operation 945 is a supersonic deceleration operation with MSPS RJ thrust only. A reverse of operation 930 is a two-step transition from MSPS to LSPS operation, e.g., from ERJ to turbojet only operation to starting the LSPS. A reverse of operation 925 is a low supersonic deceleration operation with the LSPS thrust, e.g., turbojet only trust. Low supersonic and subsonic deceleration and landing operations will be conducted with the LSPS only, e.g., with the turbojet only.

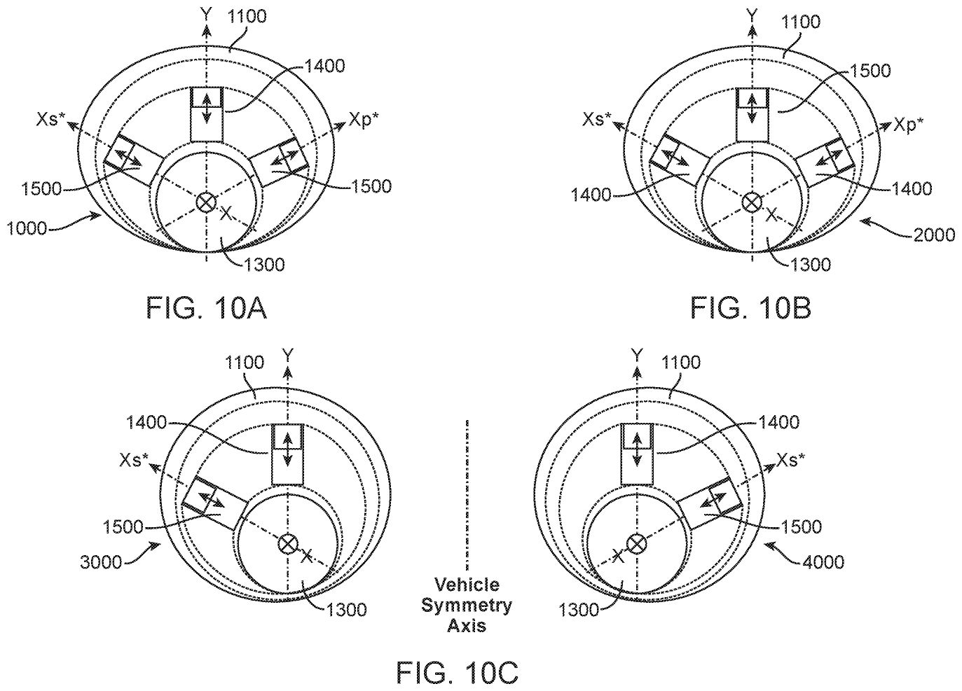

CCPS module 1000 as described above may employ a LSPS 1400, a MSPS 1500, and a HSPS 1300 in many different configurations. FIG. 10A, for example, shows a front view of a CCPS module including a central HSPS 1300 and a LSPS 1400 having flow paths with respective center lines in an X-Y plane, and an MSPS 1500 including a pair of air flow paths symmetrically located on opposite sides of the X-Y plane. For example, a DMRJ of HSPS 1300 and a turbojet of LSPS 1400 may have center lines in the same plane, and two separate ERJs of the MSPS 1500 may be located on opposite sides of the DMRJ and the turbojet. Other CCPS modules, employing the same principles disclosed herein, may employ all components that make up module 1000 but use different engine combinations and configurations. FIG. 10B shows a front view of an alternative CCPS module 2000 including a central HSPS 1300, e.g., including a DMRJ and an MSPS 1500, e.g., including one ERJ, and a LSPS 1400 including a pair of symmetric air flow paths, e.g., for two separate state-of-the-art turbojets. The configurations of FIGS. 10A and 10B have the advantage of being laterally symmetric, so that a single CCPS module may be easily employed in a flight vehicle. Both these modules are particularly suitable for smaller vehicles or test vehicles which only need one CCPS module for their propulsion. Larger vehicles may use pairs of asymmetric CCPS modules. FIG. 10C, for example, shows a front view of a pair of asymmetric CCPS modules 3000 and 4000. Each CCPS module 3000 or 4000 includes a central HSPS 1300, a LSPS 1400 with one turbine engine, and a MSPS 1500 with one ejector ramjet of about equal thrust size. CCPS modules 3000 and 4000 are mirror symmetric, so that modules 3000 and 4000 can be used together to provide laterally symmetric trust, even though the thrust from each module 3000 and 4000 alone may include a lateral component. Common to all these CCPS modules is the HSPS 1300 around which all other engine components are arranged. The shape of the inlet 1100 and the nozzle 1200 may be optimized for HSPS 1300, e.g., for DMRJ, operation because the HSPS generally has the greatest demand for air capture and flow. The size of the selected LSPS turbojet in the various configurations dictates the size of the supporting MSPS and HSPS, and the drag of a vehicle determines how many CCPS modules the vehicle requires. The operational approach of the channel flow controls and the engine fueling schedules remain the same for all configurations of one or multiple CCPS modules.

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A propulsion module comprising:
a first propulsion system capable of providing flight propulsion at a first range of speeds;
a second propulsion system capable of providing flight propulsion at a second range of speeds, the second range extending beyond the first range;
a third propulsion system capable of providing flight propulsion at a third range of speeds, the third range extending beyond the second range;
an inlet with a central channel directing a central air flow to the third propulsion system;
a set of first bypass channels connected to direct a first air flow from the inlet to the first propulsion system, the first bypass channels including a first control system adapted to control an amount of the first air flow from the inlet into the first propulsion system;
a set of second bypass channels connected to direct a second air flow from the inlet to the second propulsion system, the second bypass channels including a second control system adapted to control an amount of the second air flow from the inlet into the second propulsion system; and
a nozzle configured to receive exhaust flows from the first propulsion system, the second propulsion system, and the third propulsion system.

2. The propulsion module of claim 1, wherein the first propulsion system comprises a turbojet.

3. The propulsion module of claim 2, further comprising air conditioning system connected to provide a flow of cooling air to the turbojet during flight when the first control system curtails the first air flow.

4. The propulsion module of claim 3, wherein the air conditioning system comprises a heat exchanger coupled to receive tapped air from at least one of the second propulsion system and the third propulsion system, the heat exchanger conducting heat from the tapped air to fuel employed by the propulsion module.

5. The propulsion module of claim 4, wherein the air conditioning system further comprises an electrical generator configured to generate electrical power from expansion of the tapped air, the electrical generator driving rotation of a rotor of the turbojet.

6. The propulsion module of claim 2, wherein the second propulsion system comprises an ejector ramjet, and the third propulsion system comprises a dual mode ram jet.

7. The propulsion module of claim 2, wherein the turbojet provides propulsion at flight speeds up to at least Mach 1.8.

8. The propulsion system of claim 1, wherein one of the first propulsion system and the second propulsion system has only a single flow path, the single flow path having a center line in a first plane with a center line of the central channel.

9. The propulsion system of claim 8, wherein the other of the first propulsion system and the second propulsion system has a pair of flow paths, the flow paths of the pair being on opposite sides of the first plane.

10. The propulsion system of claim 1, wherein the first propulsion system has only a single flow path, and the second propulsion system has only a single flow path.

11. The propulsion system of claim 10, wherein one of the flow path of the first propulsion system and the flow path of the second propulsion system has a center line in a first plane with a center line of the central channel, and the other of the flow path of the first propulsion system and the flow path of the second propulsion system is located to one side of the first plane.

12. The propulsion system of claim 1, wherein the first control system comprises a pair of panels that shut off the first flow when shut and permits the first flow when open.

13. The propulsion system of claim 1, wherein the second control system comprises a pair of panels that shut off the second flow when shut and permits the second flow when open.

14. The propulsion system of claim 1, further comprising:
a set of third set of bypass channels connected to direct a first exhaust flow from the first propulsion system to the nozzle, the third bypass channels including a third control system adapted to control an amount of the first exhaust flow; and
a set of fourth bypass channels connected to direct a second exhaust flow from the second propulsion system to the nozzle, the fourth bypass channels including a fourth control system adapted to control an amount of the second exhaust flow.

15. The propulsion system of claim 1, wherein the inlet is a scarved inward turning inlet and the nozzle is a scarved outward turning nozzle.

16. A propulsion module comprising:
a first propulsion system including a turbojet capable of providing flight propulsion at a first range of speeds;
a second propulsion system capable of providing flight propulsion at a second range of speeds, the second range extending beyond the first range;
an inlet system coupled to direct a first air flow to the first propulsion system and a second air flow to the second propulsion system;
a first flow control system adapted to control an amount of the first air flow; and
air conditioning system receiving a flow of tapped air from the second propulsion system and providing a flow of cooling air to the turbojet during flight when the first control system curtails the first air flow.

17. The propulsion module of claim 16, further comprising:
a nozzle coupled to receive exhaust from the first propulsion system and the second propulsion system; and
a second flow control system adapted to control flow from the first propulsion system to the nozzle.

18. The propulsion module of claim 16, wherein the second propulsion system comprises an ejector ramjet in a first channel between the inlet and the nozzle and a dual mode ram jet in a second channel between the inlet and the nozzle.

19. The propulsion module of claim 16, wherein the air conditioning system comprises a heat exchanger coupled to receive the tapped air from the second propulsion system, the heat exchanger conducting heat from the tapped air to fuel employed by the propulsion module.

20. The propulsion module of claim 19, wherein the air conditioning system further comprises an electrical generator configured to generate electrical power from a flow of the tapped air, the electrical generator being coupled to supply the electrical power to a start motor of the turbojet.

21. The propulsion module of claim 16, wherein the cooling air has a temperature between 200° F. and 250° F.

22. The propulsion module of claim 21, wherein the tapped air is cooled in an heat exchanger to a temperature of about 1000° F. and is further cooled by expansion in a turbine that drives an electrical generator.

23. A thermal management process for operation of a propulsion module during flight of a vehicle, comprising:
shutting off fuel flow to a turbojet in a first propulsion system in the propulsion module when a flight speed of the vehicle reaches a first speed;
operating a second propulsion system in the propulsion module while the fuel flow to the turbojet is off;
directing a first air flow from an inlet of the propulsion module through the turbojet while the flight speed of the vehicle flies is between the first speed and a second speed, the first air flow cooling a rotor of the turbojet rotating while the rotor rotates;
shutting off the first air flow when the flight speed of the vehicle is above the second speed;
tapping tapped air from the second propulsion system while the flight speed of the vehicle is above the second speed; and
cooling the tapped air and directing cooled tapped air into the turbojet.

24. The process of claim 23, wherein the first speed is about Mach 1.8 and the second speed is about Mach 2.0.

25. The process of claim 23, wherein cooling the tapped air comprises directing the tapped air and fuel for the vehicle through a heat exchanger that transfers heat from the tapped air to the fuel.

26. The process of claim 25, wherein cooling the tapped air further comprises expanding the tapped air in a turbine coupled to an electrical power generator.

27. The process of claim 26, further comprising applying electrical power from the electrical generator to drive rotation of a rotor of the turbojet.

28. A process for operating a combined cycle propulsion system that includes a first propulsion system, a second propulsion system, a third propulsion system, a common inlet that provides air flows to the first, second, and third propulsion systems, and a common nozzle that receives exhaust flows to the first, second, and third propulsion systems, the process comprising:
operating the first propulsion system for propulsion during flight below a first speed;
starting operation of the second propulsion system at the first speed;
operating the first propulsion system and the second propulsion system together for propulsion during flight between the first speed and a second speed;
shutting down the first propulsion system at the second speed;
operating the second propulsion system for propulsion during flight between the second speed and a third speed; and
operating the third propulsion system for propulsion during flight at speeds above the third speed.

29. The process of claim 28, further comprising:
starting operation of the third propulsion system at the third speed;
operating the second propulsion system and the third propulsion system together for propulsion during flight between the third speed and a fourth speed; and
shutting down the second propulsion system at the fourth speed.

30. The process of claim 28, wherein:
the first propulsion system comprises a turbojet;
the second propulsion system comprises an ejector ramjet; and
the third propulsion system comprises a dual mode ramjet.

31. The process of claim 30, wherein:
the first speed is above Mach 1.8; and
the second speed is below Mach 2.0.

32. The process of claim 28, further comprising actively cooling the first propulsion system at flight speeds above the second speed.
